(19) United States
(12) Patent Application Publication
(10) Pub. No.: US 2017/0366003 A1
(43) Pub. Date: Dec. 21, 2017

(54) DEVICE FOR PROTECTING SEMICONDUCTOR CIRCUIT

(71) Applicant: SK hynix Inc., Gyeonggi-do (KR)

(72) Inventors: Sung-Ryong LEE, Gyeonggi-do (KR); Ik-Seok YANG, Seoul (KR); Kang-Bong SEO, Gyeonggi-do (KR)

(21) Appl. No.: 15/451,524

(22) Filed: Mar. 7, 2017

(30) Foreign Application Priority Data
Jun. 21, 2016 (KR) 10-2016-0077060

(51) Int. Cl. H02H 9/04; B08B 7/00

(52) U.S. Cl. CPC H02H 9/046; B08B 7/0035

(57) ABSTRACT

A semiconductor circuit protection device for protecting an input/output circuit include an ultra-low electrostatic discharging block suitable for discharging ultra-low electrostatic charges before migrating to the input/output circuit.

### CROSS-REFERENCE TO RELATED APPLICATIONS

The present application claims priority of Korean Patent Application No. 10-2016-0077060, filed on Jun. 21, 2016, which is incorporated herein by reference in its entirety.

### BACKGROUND

### 1. Field

Various embodiments of the present invention relate generally to a semiconductor device and, more particularly, to a semiconductor circuit protection device for protecting a semiconductor circuit from electrostatic charges.

### 2. Description of the Related Art

A semiconductor circuit for use in a mobile device generally employs an electrostatic discharge (ESD) device customized for the mobile device to prevent a current leakage even when power is not supplied to the mobile device.

The yield of a semiconductor assembly process is greatly affected by impurities. Accordingly, a semiconductor assembly company or a semiconductor module assembly company performs an impurity removal process to reduce product defects during an assembly of the semiconductor or the semiconductor module. Plasma cleaning is one of the most commonly used methods for removing impurities.

However, when the plasma cleaning process is carried out, electrostatic charges of very fine particles (hereinafter, referred to as “ultra-low electrostatic charges”) may be generated in a metal exposed to a plasma environment. If the ultra-low electrostatic charges pass through the ESD device of the mobile device they may then accumulate in an input/output circuit of a following stage, and as a result characteristics of the input/output circuit (e.g., a threshold voltage of a transistor) may be changed permanently. That is, the plasma cleaning process may permanently change the characteristics of an input/output circuit due to ultra-low electrostatic charges that may be introduced during the plasma cleaning.

### SUMMARY

Various embodiments of the present invention are directed to a semiconductor circuit protection device for preventing characteristics of an input/output circuit from being changed by ultra-low electrostatic charges.

Also, various embodiments are directed to a semiconductor circuit protection device for preventing a semiconductor circuit from being damaged by electrostatic charges and preventing the characteristics of the input/output circuit from being changed by the ultra-low electrostatic charges.

In accordance with an embodiment of the present invention, a semiconductor circuit protection device for protecting an input/output circuit may include an ultra-low electrostatic discharging block suitable for discharging ultra-low electrostatic charges before migrating to the input/output circuit.

In accordance with another embodiment of the present invention, a semiconductor circuit protection device may include a first protection block suitable for protecting a semiconductor circuit disposed in a following stage; and a second protection block suitable for protecting an input/output circuit in the semiconductor circuit by discharging ultra-low electrostatic charges migrating through the first protection block.

According to the embodiments of the present invention, it is possible to prevent the characteristics of the input/output circuit (e.g. the threshold voltage of a transistor) from being changed by the ultra-low electrostatic charges.

Also, according to the embodiments of the present invention, it is possible to prevent the semiconductor circuit from being damaged by the electrostatic charges and to prevent the characteristics of the input/output circuit of the semiconductor circuit from being changed by the ultra-low electrostatic charges.

The embodiments of the present invention allow to use the plasma cleaning method to remove impurities most effectively while preventing the characteristics of an internal input/output circuit from being changed by the ultra-low electrostatic charges. Thus, it is possible to enhance a yield of semiconductor products and to secure cost competitiveness accordingly.

### BRIEF DESCRIPTION OF THE DRAWINGS

FIG. 1A is a circuit diagram of a conventional electrostatic discharge (ESD) device;

FIG. 1B illustrates an example of ultra-low electrostatic charges generated during a plasma cleaning process;

FIG. 2A is a circuit diagram illustrating a semiconductor circuit protection device according to an embodiment of the present invention;

FIG. 2B is a circuit diagram illustrating a semiconductor circuit protection device according to another embodiment of the present invention;

FIG. 2C is a circuit diagram illustrating a semiconductor circuit protection device according to yet another embodiment of the present invention;

FIG. 3A is a circuit diagram illustrating a semiconductor circuit protection device according to yet another embodiment of the present invention;

FIG. 3B is a circuit diagram illustrating a semiconductor circuit protection device according to yet another embodiment of the present invention; and

FIG. 3C is a circuit diagram illustrating a semiconductor circuit protection device according to yet another embodiment of the present invention.

### DETAILED DESCRIPTION

Various embodiments will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

In this disclosure, when one part is referred to as being ‘connected’ to another part, it should be understood that the former can be ‘directly connected’ to the latter, or ‘electrically connected’ to the latter via an intervening part. The terms of a singular form may include plural forms unless referred to the contrary.

It will be further understood that the terms “comprises,” “comprising,” “includes,” and “including” when used in this specification, specify the presence of the stated elements and do not preclude the presence or addition of one or more other elements.

Terminologies used in this application may be defined as follows.

The term “ultra-low electrostatic charges” used herein is intended to refer to charges that have small quantities such as charges generated during a plasma cleaning process and may induce a current having a very small magnitude for example, of from about 1 pico ampere (pA) to about 1 milliampere (mA).

The term “semiconductor circuit” is used herein to mean a circuit that is to be protected. The semiconductor circuit includes an input/output circuit disposed in a stage next to a semiconductor circuit protection device or an electrostatic discharging block, and an internal circuit disposed next to the input/output circuit.

The term “diode” used herein is intended to include a diode device as well as a diode connection of a p-channel metal-oxide-semiconductor field-effect transistor (MOSFET) or an n-channel MOSFET having a gate terminal connected to its drain terminal.

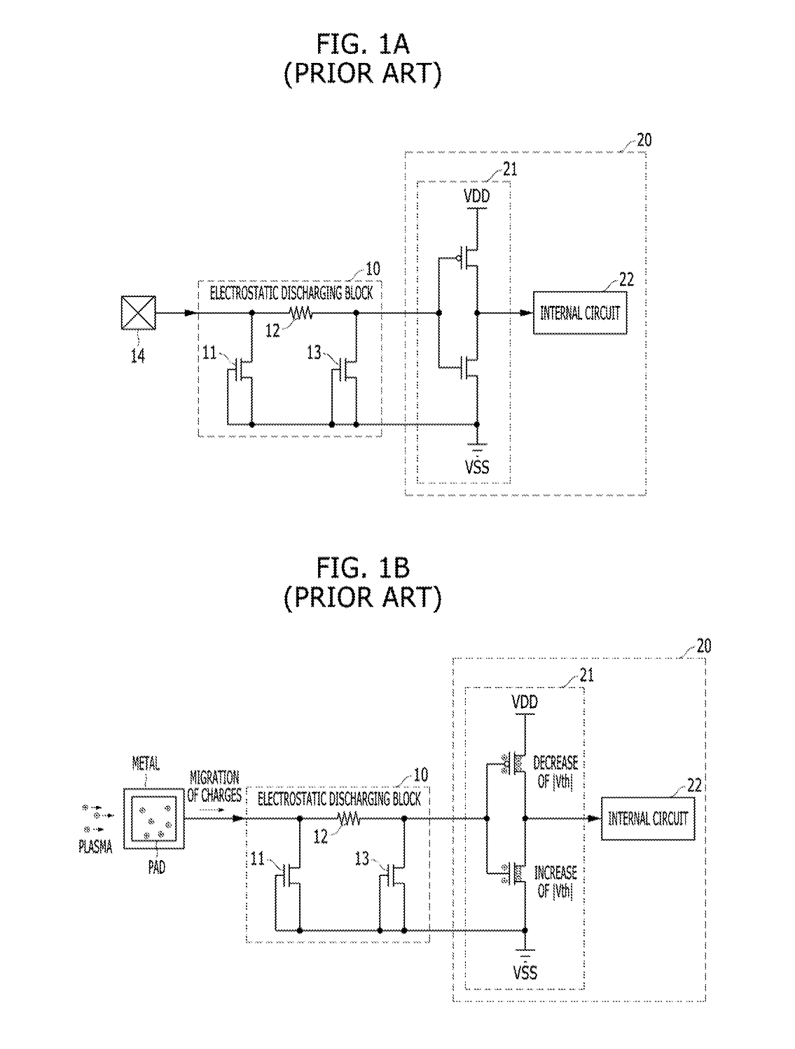

FIG. 1A is an exemplary circuit diagram of an electrostatic discharge (ESD) device illustrated to facilitate the understanding of various embodiments of the present invention.

As shown in FIG. 1A, an electrostatic discharging block 10 includes a main clamping element 11 discharging most of electrostatic charges introduced from outside through an input terminal 14, an isolation element 12 for isolating an internal semiconductor circuit 20 from the input terminal through which the electrostatic charges are introduced, and a sub-clamping element 13 for discharging residual electrostatic charges which were undischarged by the main clamping element 11 and passed through the isolation element 12 among the total electrostatic charges introduced through the input terminal 14.

The main clamping element 11 may be implemented by an n-channel MOSFET having a drain terminal connected to the input terminal, and a gate terminal and a source terminal connected to a ground VSS.

The isolation element 12 may be implemented by a resistor having a first terminal connected to the input terminal and a second terminal connected to the internal semiconductor circuit 20.

The sub-clamping element 13 may be implemented by an n-channel MOSFET having a drain terminal connected to the second terminal of the isolation element 12, and a gate terminal and a source terminal connected to the ground VSS.

The internal semiconductor circuit 20 is provided in a stage following the electrostatic discharging block 10 and includes an input/output (I/O) circuit 21 and an internal circuit 22 electrically coupled to the I/O circuit 21. The I/O circuit 21 may be, for example, an inverter circuit which is implemented by a p-channel MOSFET and an n-channel MOSFET coupled between a power supply VDD and the ground VSS, and having gates coupled to the second terminal of the isolation element 12.

The electrostatic discharging block 10 prevents the semiconductor circuit 20 including the I/O circuit 21 and the internal circuit 22 from being damaged by the electrostatic charges introduced from the outside through the input terminal.

FIG. 1B illustrates ultra-low electrostatic charges generated during a plasma cleaning process to facilitate understanding of the embodiments of the present invention.

Generally, a semiconductor assembly process adopts a plasma cleaning method to remove impurities. If, however, the plasma cleaning process is carried out in a state that the input terminal, e.g., a pad PAD, is exposed to a plasma environment as shown in FIG. 1B, ultra-low quantities of electrostatic charges are induced on the metal pad exposed to the plasma environment and the electrostatic charges are introduced to the electrostatic discharging block 10. An ultra-low current arising from the movement of the ultra-low electrostatic charges has a very small magnitude, for example, of from about 1 pico ampere (pA) to 1 about milliampere (mA).

Depending on the circumstances, the ultra-low electrostatic charges may affect the I/O circuit 21 of the next stage. In other words, the magnitude of the ultra-low electrostatic charges may be too small for the main clamping element 11 and the sub-clamping element 13 of the electrostatic discharging block 10 thus rendering the electrostatic discharging block 10 substantially inoperative to remove these charges. Hence, the ultra-low electrostatic charges may pass through the electrostatic discharging block 10 and migrate to the I/O circuit 21.

If the ultra-low electrostatic charges are introduced and accumulated in the I/O circuit 21, the characteristics of the I/O circuit 21 may change permanently. The probability that the characteristics of the I/O circuit 21 change increases when the ultra-low electrostatic charges are positive, compared to when the ultra-low electrostatic charges are negative. That is, the magnitude of a threshold voltage, |Vth|, of a transistor, i.e., the p-channel MOSFET and the n-channel MOSFET in the I/O circuit 21, may be more influenced by the positive charges than the negative charges. Such a permanent change in the characteristics of the I/O circuit 21 may result in a defective product.

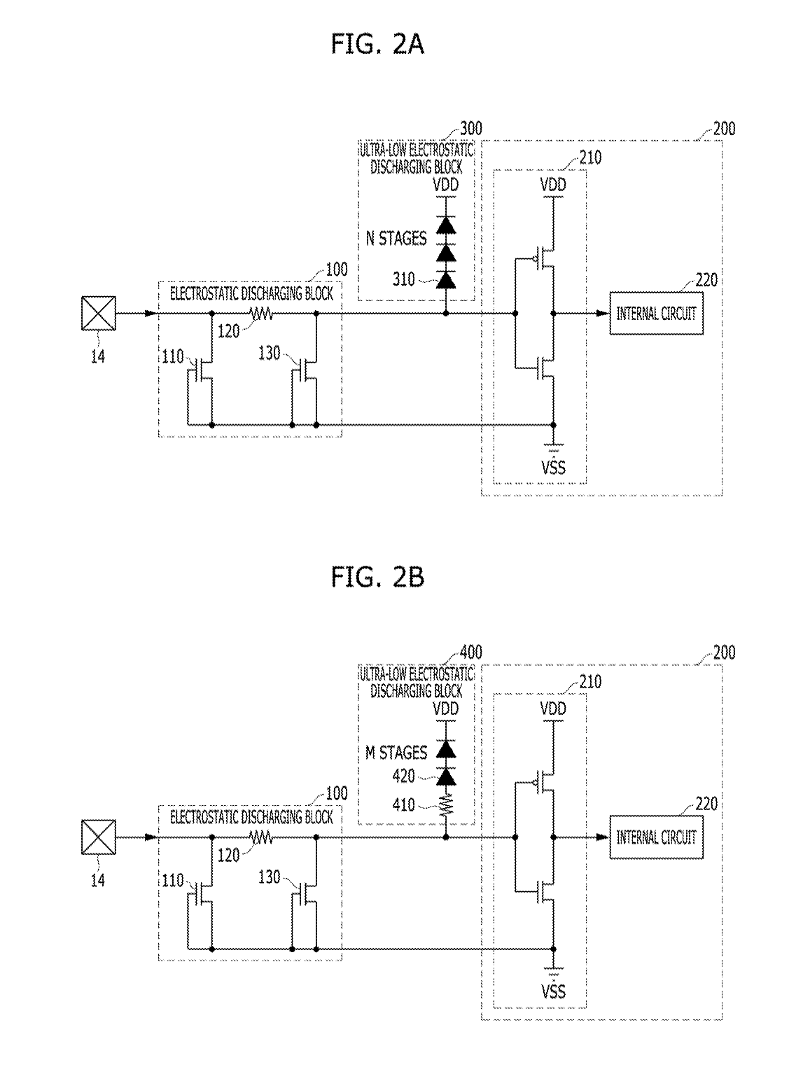

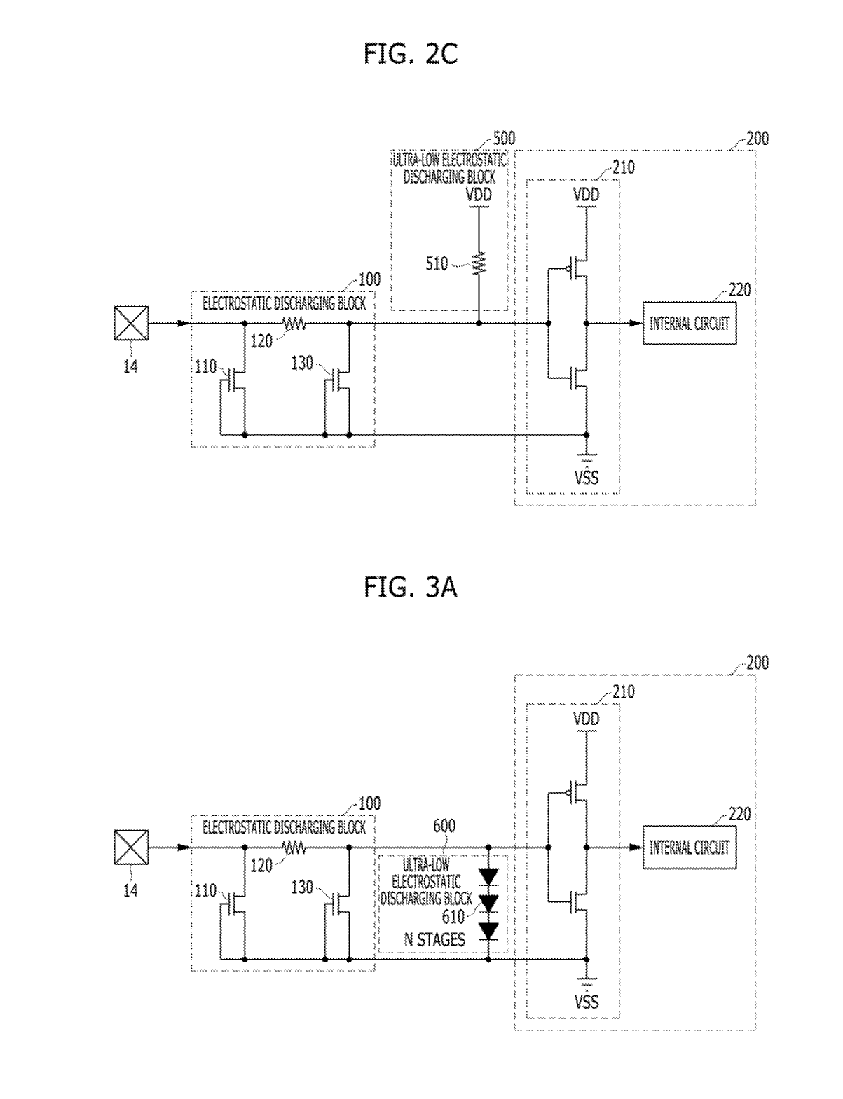

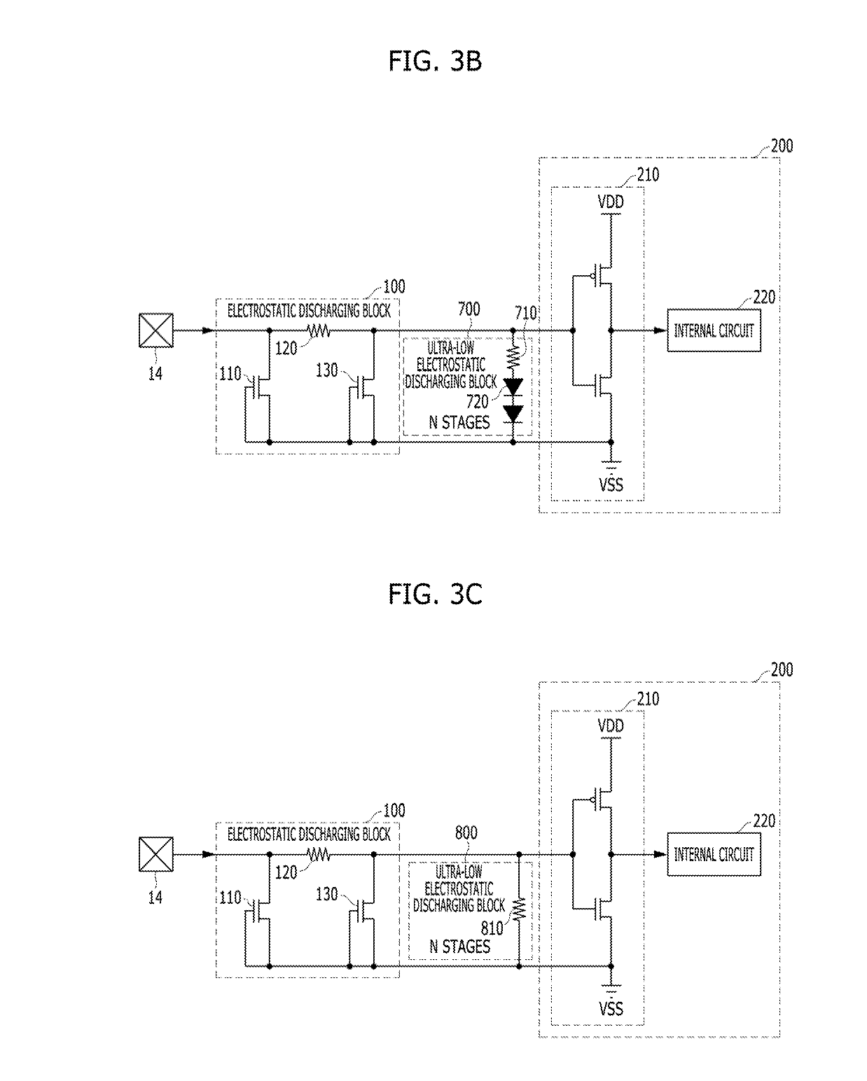

The embodiments of the present invention described below with reference to FIGS. 2A to 3C can prevent a substantial change in the characteristics of an I/O intended circuit comprising at least one transistor, i.e., the threshold voltage of the at least one transistor, caused by the ultra-low electrostatic charges.

FIGS. 2A to 2C are circuit diagrams illustrating exemplary embodiments of a semiconductor circuit protection device according to the present invention.

Referring to FIG. 2A, the semiconductor circuit protection device according to an embodiment includes an electrostatic discharging block 100 discharging electrostatic charges, and an ultra-low electrostatic discharging block 300 discharging ultra-low electrostatic charges that migrate through the electrostatic discharging block 100.

The electrostatic discharging block 100 is a first protection block for protecting a semiconductor circuit 200 that is disposed in a following stage and includes an I/O circuit 210 and an internal circuit 220, by preventing the semiconductor circuit 200 from being damaged or its characteristics been changed substantially by the electrostatic charges introduced from outside through the input terminal 14. The configuration and the operation of the electrostatic discharging block 100 are substantially the same as or similar to those of the circuit shown in FIG. 1A, and detailed descriptions of them will not be repeated. Meanwhile, instead of the electrostatic discharging block 100, the first protection block may be implemented by another device that operates in a similar manner to protect the semiconductor circuit 200 disposed next thereto. As noted above the electrostatic discharging block 100 may not discharge ultra-low electrostatic charges.

The ultra-low electrostatic discharging block 300 is a second protection block which can discharge the ultra-low electrostatic charges. Hence, the ultra-low electrostatic discharging block 300 can protect the I/O circuit 210 of the semiconductor circuit 200 by preventing a change in characteristics of the I/O circuit 210, i.e., a threshold voltage of a transistor in the I/O circuit 210, caused by the ultra-low electrostatic charges. The ultra-low electrostatic discharging block 300 may be implemented by one or more diodes, preferably a plurality of diodes 310 that form a discharging path allowing the discharge of the ultra-low electrostatic charges which migrate through the inoperative electrostatic discharging block 100. In more detail, the ultra-low electrostatic discharging block 300 may be implemented by the diodes 310 of N stages, where N is a natural number, preferably of two or more, connected in series in a direction of a power supply VDD so that an input leakage current does not flow toward the semiconductor circuit 200 even when the power supply VDD is not supplied, i.e., the power supply VDD is 0 V, and an input power source is present. That is, the ultra-low electrostatic discharging block 300 including the plurality of diodes 310 is provided between an output terminal of the electrostatic discharging block 100 (i.e., an input terminal of the I/O circuit 210) and the power supply VDD. For example, the diode 310 of a first stage may have an anode coupled to the output terminal of the electrostatic discharging block 100, and the diode 310 of an N^{th} stage may have a cathode coupled to the power supply VDD.

Meanwhile, as shown in FIG. 2B, an ultra-low electrostatic discharging block 400 in accordance with another exemplary embodiment may be implemented by a resistor 410 and one or more diodes 420 that form a discharging path allowing the discharge of the ultra-low electrostatic charges which migrate through the electrostatic discharging block 100. That is, the ultra-low electrostatic discharging block 400 may include the resistor 410 for limiting a level of the input leakage current, and diodes 420 of M stages, where M is a natural number less than N, connected in series in the direction of the power supply VDD so that the input leakage current does not flow toward the semiconductor circuit 200. According to the exemplary embodiment of FIG. 2B, the number of stages of the diodes 420 may be reduced compared with the embodiment of FIG. 2A by adding the resistor 410 to the discharging path to limit the level of the input leakage current. Though the resistor 410 is coupled between an anode of the diode 420 of a first stage and the output terminal of the electrostatic discharging block 100 in FIG. 2B, the resistor 410 may be coupled between a cathode of the diode 420 of an M^{th} stage and the supply voltage VDD.

On the other hand, as shown in FIG. 2C, an ultra-low electrostatic discharging block 500 in accordance with another exemplary embodiment may be implemented by a resistor 510 that forms a discharging path allowing the discharge of the ultra-low electrostatic charges which migrate through the inoperative electrostatic discharging block 100. For example, in case that a specification or requirement for the input leakage current is not strict, the resistor 510 limit the level of the input leakage current may serve as the discharging path for the ultra-low electrostatic charges, particularly positive charges, formed in the direction of the power supply VDD. Accordingly, the ultra-low electrostatic discharging block 500 may prevent the change in the characteristics of the I/O circuit 210 during the plasma cleaning even though the current flowing through the resistor 510 normally becomes the input leakage current.

As described above, the ultra-low electrostatic charges may be generated in the metal exposed to the plasma during the plasma cleaning process and migrate to the I/O circuit 210 and thus an electric potential due to the ultra-low electrostatic charges, particularly the positive charges, may change the characteristics of the I/O circuit 210. In accordance with exemplary embodiments of the present invention, a discharging path for discharging the positive ultra-low electrostatic charges is formed before an input terminal of the I/O circuit 210. Accordingly, the discharging path prevents the characteristics of the I/O circuit 210, i.e., the threshold voltage of the transistor, from being changed by the ultra-low electrostatic charges.

FIGS. 3A to 3C are circuit diagrams illustrating more exemplary embodiments of a semiconductor circuit protection device according to the present invention. In FIGS. 2A to 3C, like reference numerals are used to refer to the similar elements.

While the ultra-low electrostatic discharging blocks 300, 400, and 500 respectively shown in FIGS. 2A to 2C form the discharging paths in the direction of a power supply VDD, ultra-low electrostatic discharging blocks 600, 700, and 800 respectively shown in FIGS. 3A to 3C form discharging paths in the direction of a ground VSS. The other configuration and the operation of the ultra-low electrostatic discharging blocks 600, 700, and 800 respectively shown in FIGS. 3A to 3C are the same as or similar to those of the corresponding circuits 300, 400, and 500 respectively shown in FIGS. 2A to 2C, and detailed descriptions of them will not be repeated. The discharging path formed in the direction of the ground VSS does not affect the operation of the semiconductor circuit 200 and may limit the level of the input leakage current similarly to the discharging path formed in the direction of the power supply VDD.

As shown in FIG. 3A, the ultra-low electrostatic discharging block 600 accordance with an exemplary embodiment may be implemented by diodes 610 of N stages, where N is a natural number of two or more, connected in series in the direction of the ground VSS. That is, the ultra-low electrostatic discharging block 600 including the plurality of diodes is provided between an output terminal of the electrostatic discharging block 100 (i.e., an input terminal of an I/O circuit 210) and the ground VSS. Accordingly, the input leakage current does not flow toward the semiconductor circuit 200 even when an input power source is present. For example, the diode 610 of a first stage may have an anode coupled to the output terminal of the electrostatic discharging block 100, and the diode 610 of an N^{th} stage may have a cathode coupled to the ground VSS.

Also, as shown in FIG. 3B, the ultra-low electrostatic discharging block 700 in accordance with another exemplary embodiment may include a resistor 710 for limiting the level of the input leakage current, and diodes 720 of M stages connected in series in the direction of the ground VSS so that the input leakage current does not flow toward the semiconductor circuit 200. Though the resistor 710 is coupled between an anode of the diode 720 of a first stage and the output terminal of the electrostatic discharging block 100 in FIG. 3B, the resistor 710 may be coupled between a cathode of the diode 720 of an M^{th} stage and the ground VSS.

On the other hand, as shown in FIG. 3C, the ultra-low electrostatic discharging block 800 in accordance with another exemplary embodiment may include a resistor 810 that forms a discharging path allowing the discharge of the positive ultra-low electrostatic charges in the direction of the ground VSS.

According to various embodiments of the present invention a semiconductor circuit protection device is provided that is capable of preventing electrostatic charges migrating to an input/output circuit, including ultra-low electrostatic charges so that any ultra low charges that may pass through the semiconductor circuit protection device may not induce a current greater than about 1 pA.

Although various embodiments have been described for illustrative purposes, it will be apparent to those skilled in the art that various changes and modifications may be made without departing from the spirit and scope of the invention as defined in the following claims.

What is claimed is:

1. A semiconductor circuit protection device for protecting an input/output circuit, comprising:
an ultra-low electrostatic discharging block suitable for discharging ultra-low electrostatic charges before migrating to the input/output circuit.

2. The semiconductor circuit protection device of claim 1, wherein the ultra-low electrostatic discharging block prevents characteristics of the input/output circuit arranged next to the ultra-low electrostatic discharging block from being changed due to the ultra-low electrostatic charges by discharging the ultra-low electrostatic charges.

3. The semiconductor circuit protection device of claim 1, wherein the ultra-low electrostatic discharging block comprises:
a plurality of diodes forming a discharging path to discharge the ultra-low electrostatic charges migrating through an electrostatic discharging block.

4. The semiconductor circuit protection device of claim 1, wherein the ultra-low electrostatic discharging block is provided between an output terminal of an electrostatic discharging block electrostatic discharging block and a power supply.

5. The semiconductor circuit protection device of claim 4, wherein the ultra-low electrostatic discharging block comprises:
a plurality of diodes of a plurality of stages connected in series in a direction of the power supply.

6. The semiconductor circuit protection device of claim 1, wherein the ultra-low electrostatic discharging block is provided between an output terminal of an electrostatic discharging block and a ground.

7. The semiconductor circuit protection device of claim 6, wherein the ultra-low electrostatic discharging block comprises:
a plurality of diodes connected in series in a direction of the ground.

8. The semiconductor circuit protection device of claim 4, wherein the ultra-low electrostatic discharging block comprises:
a resistor and one or more diodes forming a discharging path to discharge the ultra-low electrostatic charges migrating through the electrostatic discharging block.

9. The semiconductor circuit protection device of claim 1, wherein the ultra-low electrostatic discharging block comprises:
a resistor suitable for limiting a level of an input leakage current; and
a plurality of diodes of one or more stages connected in series in a direction of a power supply.

10. The semiconductor circuit protection device of claim 1, wherein the ultra-low electrostatic discharging block comprises:
a resistor suitable for limiting a level of an input leakage current; and
a plurality of diodes connected in series in a direction of a ground.

11. The semiconductor circuit protection device of claim 4, wherein the ultra-low electrostatic discharging block comprises:
a resistor forming a discharging path to discharge the ultra-low electrostatic charges migrating through the electrostatic discharging block.

12. The semiconductor circuit protection device of claim 1, wherein the ultra-low electrostatic discharging block comprises:
a resistor forming a discharging path in a direction of a power supply to discharge the ultra-low electrostatic charges.

13. The semiconductor circuit protection device of claim 1, wherein the ultra-low electrostatic discharging block comprises:
a resistor forming a discharging path in a direction of a ground to discharge the ultra-low electrostatic charges.

14. The semiconductor circuit protection device of claim 4, wherein the electrostatic discharging block prevents a semiconductor circuit disposed in a following stage from being damaged by discharging the electrostatic charges introduced from outside through an input terminal.

15. A semiconductor circuit protection device, comprising:
a first protection block suitable for protecting a semiconductor circuit disposed in a following stage; and
a second protection block suitable for protecting an input/output circuit in the semiconductor circuit by discharging ultra-low electrostatic charges migrating through the first protection block.

16. The semiconductor circuit protection device of claim 15, wherein the second protection block comprises:
a plurality of diodes forming a discharging path to discharge the ultra-low electrostatic charges that migrate through the first protection block.

17. The semiconductor circuit protection device of claim 16, wherein the second protection block is provided between an output terminal of the first protection block and one of a power supply terminal and a ground terminal.

18. The semiconductor circuit protection device of claim 15, wherein the second protection block comprises:
a resistor and one or more diodes forming a discharging path to discharge the ultra-low electrostatic charges migrating through the first protection block due to an incomplete operation of the first protection block.

19. The semiconductor circuit protection device of claim 15, wherein the second protection block comprises:
a resistor forming a discharging path to discharge the ultra-low electrostatic charges migrating through the first protection block.

20. The semiconductor circuit protection device of claim 15, wherein the first protection block prevents the semiconductor circuit from being damaged by discharging the electrostatic charges introduced from outside through an input terminal.
